(19) United States
(12) Patent Application Publication
(10) Pub. No.: US 2003/0204711 A1
(43) Pub. Date: Oct. 30, 2003

(54) Method and system for restoring custom user configuration settings across a host application download

(76) Inventor: Alan J. Guess, Eugene, OR (US)

Correspondence Address: PSC SCANNING, INC. - STOEL RIVES LLP, C/O STOEL RIVES LLP, 900 SW 5TH AVENUE, PORTLAND, OR, 97204, US

(21) Appl. No.: 10/137,735

(22) Filed: Apr. 29, 2002

(51) Int. Cl. G06F 15/177; G06F 9/44

(52) U.S. Cl. 713/1; 717/168

(57) ABSTRACT

A method of preserving user configuration settings across a host application download to a device, such as a data reader, having a Flash memory, or other erasable memory. The existing user configuration settings of the device are stored in a secure, non-Flash, area of the device, using a common configuration description language (CDL), during the host download of the new system application, such as a firmware upgrade. The secure area is a non-volatile storage area, such as an EEPROM. After the new application is downloaded, the user configuration settings are translated into the new application's internal configuration structure and stored in the system's EEPROM, or other non-volatile memory, without the need for reprogramming. Accordingly, the original preferred user configuration settings are preserved across the application download, and may be used in conjunction with the new application.

### COMPUTER PROGRAM LISTING

A computer program listing appendix is included. The computer program listing is contained on two duplicate compact discs. The material contained on each compact disc, in file CDL-diag2, created on Jan. 28, 2002, having 8 kilobytes, is herein incorporated by reference. A portion of the disclosure of this patent document contains material which is subject to copyright protection. The copyright owner, PSC Scanning, Inc. of Eugene, Oreg., has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Data reading systems, such as point-of-sale (POS) data readers, are often equipped with user customizable configuration settings. These configuration settings may generally be modified to meet the requirements of a given user, such as a retail store that sells items encoded with one or more data symbologies, such as bar codes, RFID tags, or other code identifiers. The configuration settings generally relate to operational parameters of the data reading system, such as:

reading constraints applied to various optical code symbologies;

formatting control of optical code symbologies;

enabling and/or disabling reading of various code symbology types;

enabling and/or disabling a scale integrated with the data reader; and/or

any other parameters that may be stored in the system's non-volatile memory, such as an EEPROM (electrically erasable programmable read only memory).

The operational firmware of such systems is commonly upgraded to reflect improvements in technology, to recognize new types of symbologies, to make the data readers compatible with various accessories, and/or to make the data reading systems more effective and efficient. To upgrade the firmware, a software application having the upgrade configuration is generally downloaded from a host (e.g., the POS terminal) to a Flash memory of the data reader. The data reader may then use the upgraded firmware when performing its data reading functions.

When a firmware upgrade is downloaded to the Flash memory of a data reader, however, the upgrade may have a different configuration structure than that of the firmware previously used by the data reader. As a result, the upgraded firmware may not be able to interpret user configuration settings that were previously modified by a user under the old firmware format. This results in the preferred user configuration settings being reset to their default values when the firmware upgrade is downloaded to the system. Accordingly, the user's preferred configuration settings must be reset or reprogrammed every time that a firmware upgrade, or other application, is downloaded to the Flash memory of the data reader.

The process of programming or setting operational parameters to meet a given user's needs is often a lengthy and time-consuming process. Additionally, in many cases, the user is not trained in system programming, or is unable to readily modify the configuration settings, and therefore must use an outside source, such as a qualified service technician, to perform the programming operations. In some cases, the user may actually have to send the data reader away to a service technician for programming if a technician is not available in the user's geographic region. In such a case, the user will be without the data reader for an extended period of time, during which the data reader is shipped to the technician, upgraded and reprogrammed by the technician, and then shipped back to the user.

As a result, the user often has to expend considerable time and money to upgrade its data readers and to reset the operational parameters of the data readers to meet the user's individual requirements. Furthermore, in cases where the data readers must be sent away for upgrading, the user may have to send individual data readers away one unit at a time, or in small numbers, so that the user will still have operational data readers remaining at the user's place of business. In such cases, the number of open checkout aisles at the user's place of business may have to be reduced while one or more data readers are being upgraded, which may lead to longer lines at the checkout counters, and in turn, dissatisfied, frustrated, and/or irritated customers.

Even in cases where users are able to reset the configuration settings on their own, the process of reprogramming is very time-consuming. Moreover, the time required to perform the reprogramming process increases with the number of data readers that the user upgrades, as each data reader must be individually upgraded. Thus, the reprogramming process may be very lengthy, especially for users that utilize a large number of data readers in their places of business.

### SUMMARY OF THE INVENTION

The present invention is directed to a method and system for preserving user configuration settings in a device having Flash memory, or other erasable memory, across a host application download. The device may be a data reader, or other Flash-based device, in which custom user configuration settings may be programmed to meet the needs of a given user. The user configuration settings may preferably include the operational parameters of the system, such as the data reading parameters of a data reader, or may include other operational parameters stored in the system's EEPROM, or other non-volatile memory.

The existing user configuration settings may be stored in a secure, non-Flash, area of the device, in a common configuration description language, during the download of a new system application, such as a firmware upgrade, to the Flash memory of the system. The system may then be reset and the operational parameters may be converted from the common configuration description language into the configuration structure of the new application. The operational parameters having the new application configuration structure may then be stored in the non-volatile memory of the system. Accordingly, the original user configuration settings are stored in the nonvolatile system memory without the need to reprogram the system.

Further objects, features, and advantages of the invention will be better understood from the following description considered in connection with the accompanying drawings in which various embodiments of the invention are illustrated by way of example.

### BRIEF DESCRIPTION OF THE DRAWINGS

FIG. 1 is a schematic diagram of a data reading system according to a preferred embodiment.

FIG. 2 is a partly diagrammatic representation of the system of FIG. 1.

FIG. 3 is a flow diagram of a method of preserving user configuration settings according to a preferred embodiment.

FIG. 4 is a flow diagram of a method of preserving user configuration settings across a firmware upgrade according to a preferred embodiment.

### DETAILED DESCRIPTION OF THE PREFERRED EMBODIMENTS

Preferred embodiments will now be described with reference to the drawings. For ease of reference, any reference character identifying an element in one figure will represent the same element in any other figure.

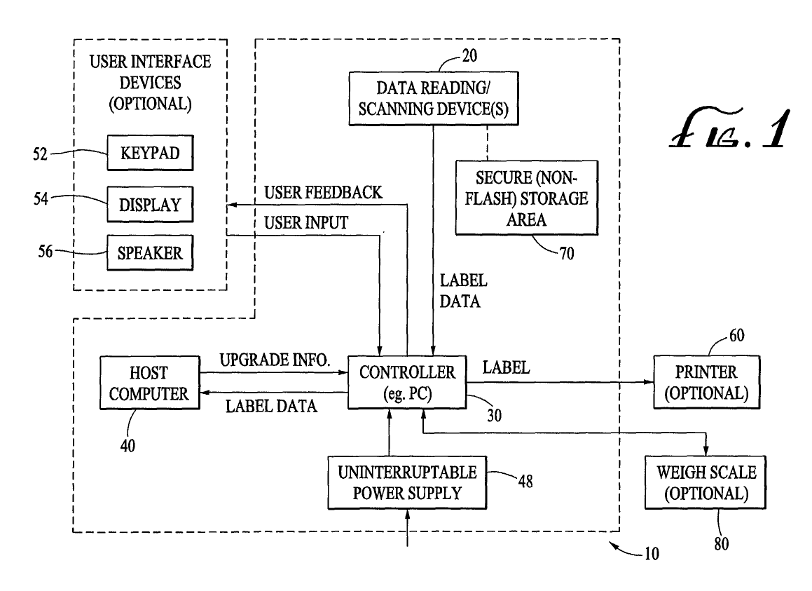

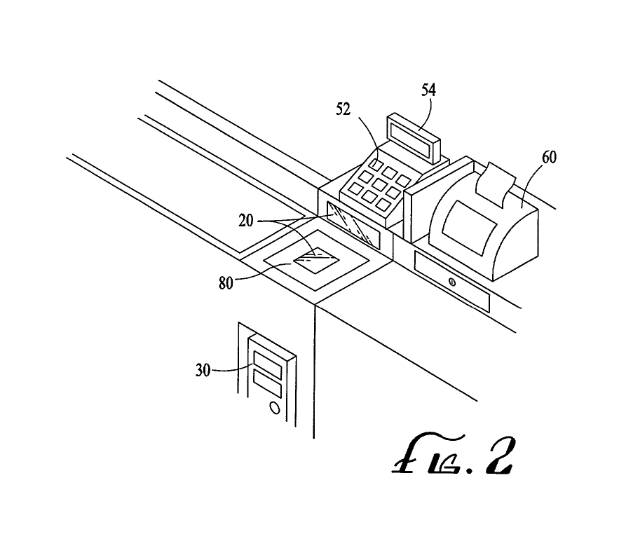

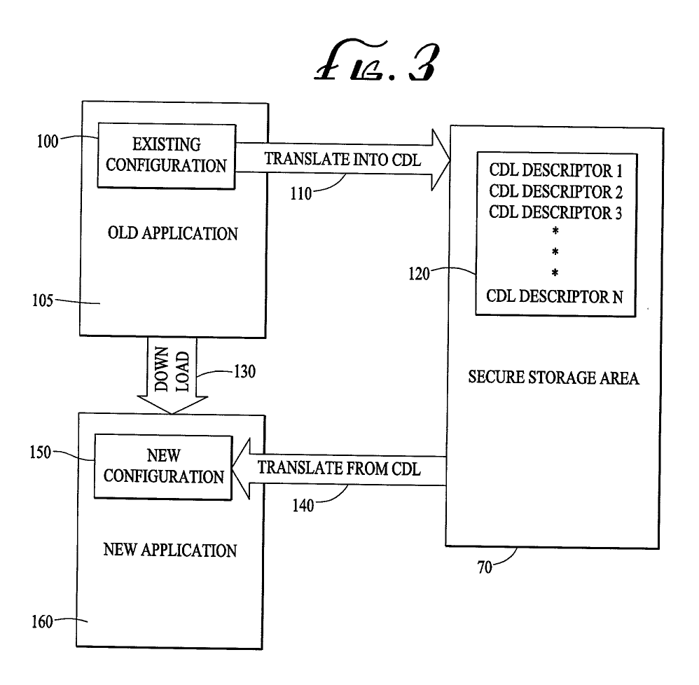

FIGS. 1 and 2 illustrate a preferred embodiment of a data reading system 10 in which a preferred method of preserving user configuration settings may be implemented. The preferred method may also be used in any other device having an erasable memory, such as a Flash memory. For ease of reference, only the data reading system 10 will be described herein, but it is to be understood that the preferred method may be used in any system having an erasable memory.

In a preferred embodiment, the data reading system 10 is part of a computer based system for reading code identifiers affixed to retail products or other codable items. The data reading system 10 may be configured to read bar codes, RFID tags, and/or any other suitable code identifiers used to identify items. The data contained within a code identifier affixed to an item may be used to identify the item, its price, and/or other characteristics or information related to checkout or inventory control.

The data reading system 10 preferably includes a reading device 20, such as a laser scanner, CCD-type imaging scanner, or other suitable reader, which communicates to a host computer 40, such as a POS terminal, via a controller 30. The data reader 20 may be L-shaped comprising both a horizontal and a vertical window, as well as a weigh scale 80, as embodied in the Magellan® scanner/scale, for example, manufactured by PSC Scanning, Inc. of Eugene, Oreg. Various configurations of such a scanner/scale are disclosed in U.S. Pat. No. 5,475,207, which is herein incorporated by reference. Alternatively, a separate weigh scale in communication with the data reader 20 may be included in the data reading system 10.

The data reader may also be equipped with, in communication with, or integrated with an electronic article security (EAS) deactivation module for deactivating EAS tags at the checkout counter of a user's place of business. Such tags are commonly affixed to items for surveillance purposes and to prevent and deter theft from retail establishments.

When a customer purchases an item having an EAS tag affixed thereto, the checkout operator preferably moves the item through the scan volume of the deactivation module to deactivate the tag, such that an alarm is not sounded when the item passes through detectors at the store exit. On the other hand, when a customer attempts to shoplift an item, the detectors at the store exit recognize the active EAS tag as the item passes between them, and an alarm is sounded to alert store security to the potential theft.

The data reader 20 preferably includes a microprocessor for accessing software downloaded to the system memory, and for performing a number of other data reading functions. Software for implementing the method of preserving user configuration settings described herein will be referred to as “setting preservation software.” Relevant portions of an exemplary software code listing, which may be stored in the system memory, are included in the above-referenced computer program listing appendix. General operation of the setting preservation software is described below.

The controller 30 may comprise a PC or other suitable processor-based controller, which may support a real time multitasking operating system. The use of a standard PC as a system controller helps to keep the overall cost of the system low.

Running under a real-time, multi-tasking operating system such as QNX or UNIX, the dedicated controller 30 is used as the system controller to interface to various components within the system, such as one or more of the following: the data reader 20, the weigh scale 80, a key pad 52, a multi-line display 54, a speaker 56, a power supply 48, the host computer system 40, a printer 60, and any other suitable system components. A data reading system including all of these components is described in U.S. Pat. No. 6,189,784, which is herein incorporated by reference.

The system may be configured for operation by an operator, such as by reading programming labels, or from a remote location via the host network. Once the system is configured, the operator may use the data reader 20 to obtain symbol information from items bearing code identifiers, as further described below.

The data reader 20 preferably includes a Flash memory, in which the computer code that dictates the various functions of the data reader is preferably stored. New applications, such as firmware upgrades, software applications, and data tables may preferably be downloaded to the Flash memory of the data reader. The Flash memory of the data reader preferably comprises a nonvolatile memory, which requires no external source of power to maintain the data stored therein.

The data reader 20 preferably further includes one or more other non-volatile memory locations, such as an EEPROM, in which operational parameters, or configuration settings, of the data reader may be stored. The additional non-volatile memory location may alternatively comprise a hard drive, a battery-backed up PAM, a separate Flash memory, a removable storage medium (e.g., a floppy disk), or any other suitable memory location that retains data when no external power is supplied to the system.

The operational parameters are preferably modifiable to meet the requirements of a given user. These operational parameters may include one or more of the following, as well as any other suitable settings that may be stored in the system's non-volatile memory:

reading constraints applied to various optical code symbologies;

formatting control of optical code symbologies;

enabling and/or disabling reading of various code symbology types;

enabling and/or disabling a scale integrated (or in communication) with the data reader;

enabling and/or disabling auto discrimination of code types;

enabling and/or disabling label assembly or stitching; or

modification of the depth of field or read zone of the data reader.

These operational parameters may be modified from their default settings by using programming labels, or by any other suitable method. For certain operational parameter modifications, such as modifying the depth of field of the data reader, a qualified service technician may be required to properly program the data reader in order to modify the settings.

In existing Flash-based devices, when a new application, such as a firmware upgrade, is downloaded to the Flash memory of the device, the upgrade configuration is often unable to read the existing preferred custom user settings. As a result, the user configuration settings are set to the default values of the upgraded firmware.

Thus, whenever a firmware upgrade is downloaded to the data reader's Flash memory, the custom user settings will likely have to be reprogrammed, either by the user or by a qualified service technician. This process generally requires substantial time and effort on the part of the user, especially in cases where the user has to modify the operational parameters of several data readers.

Additionally, in cases where the user has to send one or more data readers away for service, such as when a qualified service technician is not located near the user's place of business, the user will likely be without the data readers for a significant period of time. The cost of shipping the data readers and having the data readers upgraded may also be substantial. Thus, the reprogramming process may be both time-consuming and expensive for the user.

In order to preserve the user's custom settings under current procedures, a technician may manually save and reload the preferred settings by the steps of:

(1) plugging a PC into the data reader;

(2) extracting the user's custom settings from the data reader and storing them in a secure location within the PC memory (preferably in a common configuration description language, as described below);

(3) downloading the new application from the PC into the Flash memory of the data reader;

(4) resetting the data reader;

(5) translating the user settings into the configuration structure of the new application (which is able to read the common CDL and to process the translation); and

(6) sending the user settings having the new application configuration structure from the PC to the EEPROM, or other non-volatile memory, of the data reader.

The settings are preferably translated from their existing structure, which may be a packed binary structure or other configuration, into a common configuration description language (CDL) that both the data reader and the PC are able to interpret. A common CDL is used so that the configuration settings may be read by a new application having a different language structure than that used by the existing application, but that is able to read the CDL.

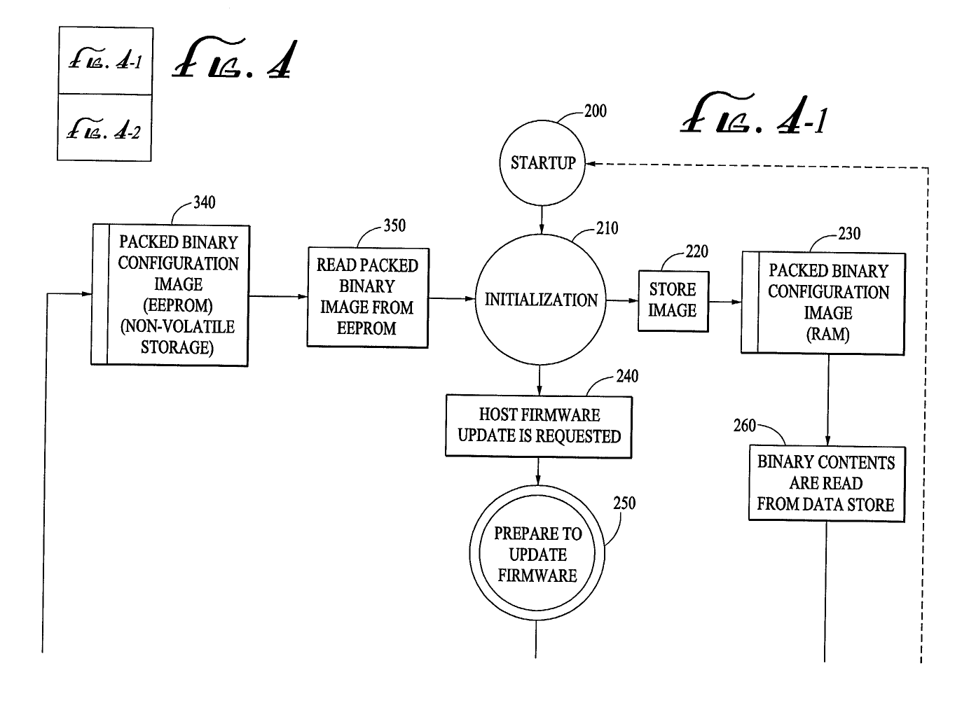

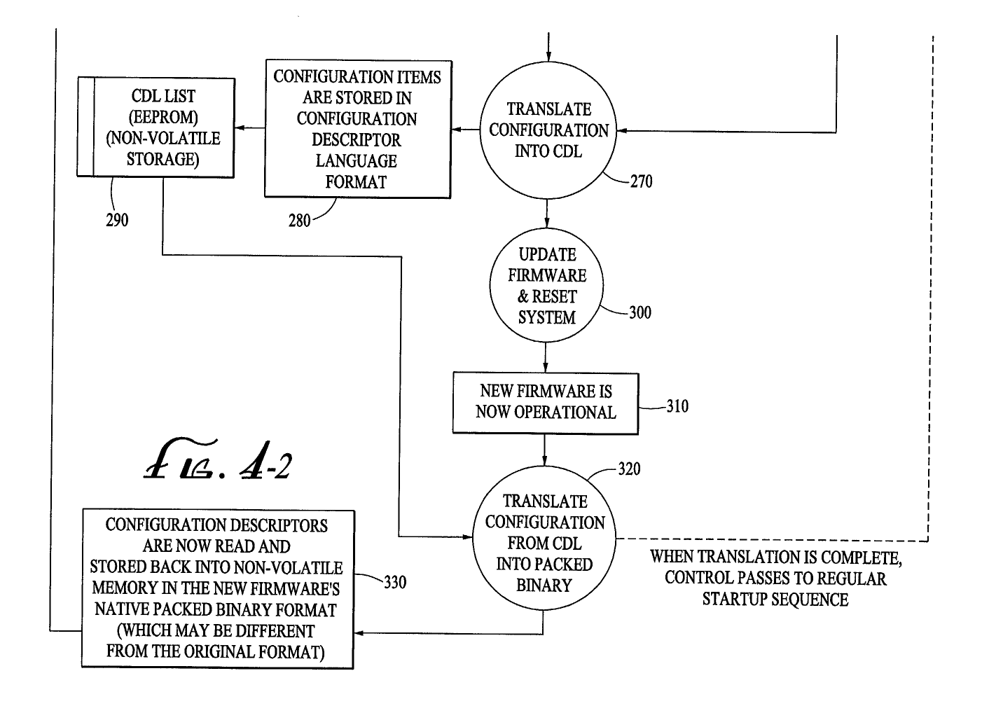

FIGS. 3 and 4 illustrate a data reading system 10 according to a first preferred embodiment, having firmware (and/or software) capable of interpreting a common CDL. Systems that are not equipped with such firmware will require an initial firmware upgrade to enable common CDL interpreting.

FIG. 3 illustrates a general overview of a preferred method of preserving user configuration settings. When a new application 160 is to be downloaded to the Flash memory of a data reader, or other device, the setting preservation software converts or translates the user configuration settings from the existing language configuration 100 of the old application 105 into a common CDL 120, as shown in step 110. The setting preservation software then instructs the system to store the converted user configuration settings in a secure, non-Flash, storage area 70 within the system, such as the system's EEPROM.

In a preferred embodiment, when a new application is about to be downloaded to the Flash memory of a device, the setting preservation software automatically instructs the system to convert and store the user configuration settings in a secure area 70 of the device, before the application is downloaded. Alternatively, the user may be given the option to convert and store the user configuration settings, via a message prompt or other suitable indicator.

Once the configuration settings are safely stored, the new application may be downloaded from a POS terminal, or other host, to the Flash memory of the device, as shown in step 130. The new application 160 is configured to interpret the common CDL 120 so that the user settings may be read and translated into the language configuration 150 of the new application 160 after the upgrade is performed, as further described below. The system 10 may then be reset, so that the new application is operational.

once the new application is running, the setting preservation software preferably converts or translates the user configuration settings from the common CDL 120 into the language configuration 150 of the new application 160, and stores the configuration settings in the system's EEPROM, or other nonvolatile memory, as shown in step 140. The new language configuration 150 may be a packed binary configuration, or any other suitable language configuration, and may further comprise a different configuration than the previously existing language configuration 100.

By using a common CDL, preferred user configuration settings may be transferred between applications having different internal configuration structures. As long as both applications are able to read and interpret the CDL, the configuration settings may be converted to and from the CDL, and may be used by applications having different language structures.

Thus, the preferred user configuration settings are converted to the new application language structure within the device itself, and may be used in conjunction with the new application without the need for a service technician to reprogram or otherwise preserve the user configuration settings.

FIG. 4 is a flow diagram illustrating a preferred embodiment of a method of preserving user configuration settings across a firmware upgrade in a data reader. First, the data reader is started up at step 200 and initialized at step 210. The user configuration settings are then stored in the random access memory (RAM), or other suitable memory location, of the data reader, at step 220. The user configuration settings may be encoded and stored in a first packed binary configuration image at step 230, or in any other suitable data storage configuration.

When a host firmware upgrade is requested by a user at step 240, the system prepares to update the firmware at step 250. The configuration settings are preferably read by the setting preservation software at step 260 and translated into a CDL at step 270. The configuration settings having the CDL format are then stored in a list at step 280, or other suitable format, within a secure non-volatile storage area or element of the system, such as the EEPROM at step 290 or other secure non-Flash memory location.

The non-volatile memory location may alternatively comprise a hard drive, a battery-backed up RAM, a separate Flash memory that is not erased when a new application is downloaded to the first Flash memory, a removable storage medium (e.g., a floppy disk), or any other suitable memory location that retains data when no external power is supplied to the system.

In an alternative embodiment, instead of the EEPROM and the Flash memory comprising separate storage elements within the device, they may comprise segregated sections of a single memory location, or may be combined into a single memory unit, such as a Flash EEPROM having a secure storage area associated therewith. As long as a secure storage area is provided in which the user configuration settings may be stored, a firmware upgrade or other application may be downloaded to the Flash memory of the data reader, and the configuration settings may be preserved across the download.

After the configuration settings are stored in the secure memory area 70 of the data reader, at step 300 the firmware upgrade is downloaded to the Flash memory and the system is reset. At step 310, the new firmware is operational and the configuration settings may be translated into the packed binary format at step 320, or other suitable format, of the new firmware.

The converted configuration settings are then read by the new firmware and preferably stored in the data reader's EEPROM, or other non-volatile memory location, in the new firmware's configuration image at step 330. The new firmware's configuration image may be a packed binary configuration image at step 340, or any other suitable data configuration image, and may further be different than the original firmware's configuration image, as enabled by the use of the common CDL.

At step 350, the system may then read the configuration image of the upgraded firmware from the nonvolatile memory. At this point, the system is ready to perform its data reading functions using the preferred user configuration settings in conjunction with the upgraded firmware.

In this manner, preferred user configuration settings, or other operational parameters, may be maintained within a device across an application download, such as a firmware upgrade, to the Flash memory of a data reader. Thus, the need to reprogram or otherwise externally preserve the user configuration settings is eliminated, as is the need to send the data readers away for programming by a service technician. As a result, users may save considerable time and/or money when upgrading data readers.

An exemplary preferred method of preserving operational parameters across the download of a firmware upgrade to a data reader may be performed by the steps of:

(1) converting the operational parameters from an existing configuration structure into a common configuration structure;

(2) storing the operational parameters having the common configuration structure in a secure memory location within the data reader;

(3) downloading the firmware upgrade to the Flash memory of the data reader;

(4) resetting the data reader;

(5) converting the operational parameters from the common configuration structure into a new configuration structure corresponding to the firmware upgrade; and

(6) storing the operational parameters having the new configuration structure in a non-volatile memory, such as the EEPROM, of the data reader.

An exemplary data reading system that may be used to implement the preferred method of preserving operational parameters across the download of a firmware upgrade, may include:

a data reader;

a Flash memory within the data reader;

a secure, non-volatile, data storage area within the data reader for storing and preserving the operational parameters in a common configuration description language;

a host, such as a POS terminal, in communication with the data reader for downloading an application to the Flash memory of the data reader; and

software for converting the user configuration settings from a first configuration language into the common configuration description language, and from the common configuration description language into a second configuration language corresponding to the downloaded application.

While data reading systems have been described herein by way of example, it is to be understood that any system or device having a Flash memory, or other erasable memory, may also utilize the method of preserving user configuration settings described herein. Accordingly, the described method is not intended to be limited to use in data reading systems.

Thus while embodiments and applications of the present invention have been shown and described, it would be apparent to one skilled in the art that other modifications are possible without departing from the inventive concepts herein. The invention, therefore, is not to be restricted except in the spirit of the claims that follow.

What is claimed is:

1. A method of downloading an application into an erasable memory of a data reader, comprising the steps of:
converting operational parameters of the data reader from an existing configuration structure into a common configuration structure;
storing the operational parameters having the common configuration structure in a secure memory location within the data reader;
downloading the application to the erasable memory of the data reader;
converting the operational parameters from the common configuration structure into a new configuration structure corresponding to the application;
storing the operational parameters having the new configuration structure in a non-volatile memory of the data reader.

2. The method of claim 1 further comprising the step of resetting the data reader after downloading the application to the erasable memory.

3. The method of claim 1 wherein the existing configuration structure comprises a first packed binary configuration, and the new configuration structure comprises a second packed binary configuration that is different from the first packed binary configuration.

4. The method of claim 1 further comprising the step of storing the operational parameters having the new configuration structure in a RAM within the data reader after the operational parameters are stored in the non-volatile memory.

5. The method of claim 1 wherein the step of downloading the application to the erasable memory comprises downloading a firmware upgrade to a Flash memory of the data reader.

6. The method of claim 1 wherein the step of downloading the application to the erasable memory comprises downloading a software application to a Flash memory of the data reader.

7. The method of claim 1 wherein the step of downloading the application to the erasable memory comprises downloading a data table to a Flash memory of the data reader.

8. The method of claim 1 wherein the step of storing the operational parameters in a non-volatile memory of the data reader comprises storing the operational parameters in an EEPROM within the data reader.

9. The method of claim 1 wherein the step of storing the operational parameters in a non-volatile memory of the data reader comprises storing the operational parameters in a Flash memory within the data reader.

10. A data reading system having custom configuration settings comprising:
a data reader having (1) an erasable memory for storing an application, (2) a non-volatile, non-Flash memory for storing custom configuration settings, the custom configuration settings being in a first configuration language, and (3) a secure data storage area therein;
a host in communication with the data reader for downloading an application to the erasable memory of the data reader;
software for (1) converting the custom configuration settings from the first configuration language into a common configuration description language, (2) storing in the secure data storage area the custom configuration settings in the common configuration description language, (3) converting the custom configuration settings from the common configuration description language into a second configuration language corresponding to the application downloaded from the host, and (4) storing the custom configuration settings in the second configuration language into the non-volatile, non-Flash memory.

11. The system of claim 10 wherein the secure data storage area is located in the non-volatile, non-Flash memory.

12. The system of claim 10 wherein the non-volatile, non-Flash memory comprises an EEPROM.

13. The system of claim 10 wherein the erasable memory comprises a Flash memory.

14. The system of claim 10 further comprising a RAM within the data reader for storing the user configuration settings.

15. The system of claim 10 wherein the host comprises a POS terminal.

16. The system of claim 10 wherein the application downloaded from the host comprises a firmware upgrade.

17. A system having custom operational parameters and application download capabilities to a Flash-based device, comprising:
a device having a Flash memory and a non-voaltile, non-Flash memory contained therein;
a secure data storage area within the device for storing custom operational parameters in a common configuration structure;
a host in communication with the device for downloading an application to the Flash memory of the device;
software for (1) converting the custom operational parameters from a first configuration structure into the common configuration structure, (2) storing in the secure data storage area the custom operational parameters in the common configuration structure, (3) converting the custom operational parameters from the common configuration structure into a second configuration structure corresponding to the application downloaded from the host, and (4) storing the custom operational parameters in the second configuration structure into the nonvolatile, non-Flash memory.

18. The system of claim 17 wherein the secure data storage area is located in the non-volatile, non-Flash memory.

19. The system of claim 17 wherein the non-volatile, non-Flash memory location comprises an EEPROM.

20. The system of claim 17 wherein computer code is stored in the Flash memory.

21. The system of claim 17 further comprising a RAM within the device for storing the operational parameters.

22. The system of claim 17 wherein the device comprises a data reader.

23. The system of claim 22 wherein the data reader comprises a laser scanner for scanning optical codes.

24. The system of claim 22 wherein the data reader comprises an RFID reader for reading RFID tags.

25. The system of claim 17 wherein the device comprises an EAS tag deactivation device.

26. The system of claim 17 wherein the host comprises a POS terminal.

27. The system of claim 17 wherein the application downloaded from the host comprises a firmware upgrade.
